(19) United States
(12) Patent Application Publication
(10) Pub. No.: US 2021/0396266 A1
(43) Pub. Date: Dec. 23, 2021

(54) INSERT SCREW SLEEVE, CONNECTING BOLT, BOLT-SLEEVE COMBINATION, AND COMPONENT THEREWITH

(71) Applicant: ILLINOIS TOOL WORKS INC., Glenview, IL (US)

(72) Inventors: Nelson SANTOS, Iserlohn (DE); Bruno DA ROCHA, Altena (DE); Sven BECKER, Bochum (DE)

(21) Appl. No.: 17/343,923

(22) Filed: Jun. 10, 2021

(30) Foreign Application Priority Data
Jun. 22, 2020 (DE) 10 2020 116 402.5

(51) Int. Cl. F16B 39/06

(52) U.S. Cl. CPC F16B 39/06

(57) ABSTRACT

An insert threaded sleeve (1) includes a shank portion (2) extending substantially cylindrically along a sleeve axis (z) for insertion into a hole (32) or a bore; a disc portion (3) terminates the shank portion at an axial end and extends it outward at a right angle to the sleeve axis; a through-hole (5) extends along the sleeve axis through the disc portion and the shank portion for receiving a screw bolt; a component anti-rotation means (11) is configured on an outer surface (10) of the shank portion or on an underside of the disc portion facing toward the shank portion; and a screw anti-rotation structure (15) is configured on a surface (14) of the disc portion facing away from the shank portion. A connecting screw and a screw-sleeve combination are also provided.

### TECHNICAL FIELD

The invention relates to an insert threaded sleeve for a screw connection, a connecting screw, a screw-sleeve combination and a component, in particular a high-voltage plug (housing), having a preassembled sleeve or screw-sleeve combination.

### BACKGROUND

Attaching components made of plastic, such as housings of plug connectors, to support structures by means of a screw connection is well-known. In particular in the automotive industry, but also in other fields, given the occurring mechanical loads, such as vibrations, high demands are placed on the security of such screw connections against loosening. In particular in the case of high-voltage plugs for electric vehicles via which high-voltage drive current is transmitted, a secure connection of the insulating plastic housings to a drive motor or a power source or power distribution system is especially important. Therefore a comparatively high tightening torque is required to apply the necessary pretension in the screw connection. This in turn requires a certain minimum screw length or screw-in depth and thus a comparatively large wall thickness on the structural component. A high screwing pressure moreover also exerts a high mechanical load on the screwed component. The use of pressed-in or cast-in metal sleeves at the screw points of such a component to accommodate a connecting screw is well-known in this situation. This design requires a high degree of dimensional accuracy for the metal sleeve and the component wall and possibly assembly with controlled torque to, on the one hand, reliably absorb and guide the pretensioning forces into the structure without squeezing the component and, on the other hand, enable the component to rest securely against the structure, and thus prevent the press connection between the component and the sleeve or between the component and the structure from loosening or wearing out. Furthermore, depending on the number of screw points, a large number of screws have to be handled in addition to the component itself, and they have to be inserted in a positionally and angularly accurate manner.

### SUMMARY

The object of the invention is to at least partially avoid the aforementioned disadvantages in the prior art. It is therefore an object of the invention to create or enable a screw connection in the above-described context that is improved with respect to at least one of the abovementioned disadvantages. For example, one object of the invention is to facilitate a screw assembly of a component to a structure. Another object is, for example, to enable improved, in particular captive preassembly of the connecting screws on the component. A further object is to enable a screw connection without or with a significantly reduced pretensioning force, for example. By reducing the pretensioning force many advantages could be achieved which correspond to further subtasks of the invention. The thread length could be reduced, for example, and with it also the wall thickness of the structural component, which would result in further advantages such as space savings, weight savings and a reduction in assembly times. Introduction of pressure into the structural component via the sleeve could possibly also become unnecessary, as a result of which the sleeve could be shorter than the hole, provided that the lower clamping force can also be transmitted through the wall of the component, and the requirements for manufacturing accuracy between the sleeve and the component could then also be reduced. A further object is to make the monitoring of the tightening torque unnecessary, for example, and thereby further simplify and accelerate the assembly.

At least partial aspects of the object are achieved by the features of the independent claims. Advantageous further developments and preferred embodiments are the subject matter of the subclaims.

An insert threaded sleeve according to the invention comprises a shank portion which extends substantially cylindrically along a sleeve axis, a disc portion which terminates the shank portion at an axial end and extends it outward at a right angle to the sleeve axis, and a through-hole which extends along the sleeve axis through the disc portion and the shank portion, wherein the insert threaded sleeve comprises:
a component anti-rotation means, which is configured on an outer surface of the shank portion or on an underside of the disc portion facing toward the shank portion; and
a screw anti-rotation means, which is configured on a surface of the disc portion facing away from the shank portion.

An insert threaded sleeve (hereinafter also simply referred to as “sleeve”) in the sense of the invention is a sleeve which is configured for insertion into a bore of a receiving component by means of the shank portion and for receiving a screw bolt in the through-hole. The insertion of the sleeve into the component can be effected using per se known measures, such as pressing in, hammering in, molding in, etc., wherein the disc portion limits the insertion depth. The receptacle for the screw bolt can be prepared by providing an internal thread or a nut core diameter of the through-hole adapted to a nominal screw diameter. An anti-rotation means in the sense of the invention is an anti-rotation means by means of a friction or form fit. It can in particular be a geometric or structural anti-rotation means in the sense that geometric structures are provided that can inhibit rotation. The component anti-rotation means enables inhibition of rotation of the sleeve relative to a shank portion of the insert threaded sleeve in a fastening bore of a receiving component about the sleeve axis. The screw anti-rotation means enables inhibition of rotation of a bolt head of a bolt inserted into the through-hole from the one axial end relative to the insert threaded sleeve about the sleeve axis. Because of the screw preparation, an improved, in particular captive preassembly of the connecting screws on the component is possible. Screw assembly of the component on a structure can thus be facilitated. The twofold anti-rotation means, between the component and the sleeve and also between the sleeve and the screw head, makes it possible to produce a screw connection without or with a significantly reduced pretensioning force, which is associated with the mentioned advantages. A suitable configuration of the screw anti-rotation means, for example by means of a finely graduated catch, can also make monitoring of the tightening torque unnecessary, because the worker has to tighten the screw only by a specific defined number of catches determined such that the screw anti-rotation means reliably takes effect in terms of rotation inhibition, which can simplify and accelerate assembly considerably.

In embodiments, the component anti-rotation means and/or the screw anti-rotation means has a preferred direction. A preferred direction of an anti-rotation means is to be understood to mean that it is relatively easy to overcome in one direction, which is also referred to as the direction of rotation, and relatively difficult to overcome in the other direction of rotation, which is also referred to as the direction of inhibition. The preferred direction of the component anti-rotation means and that of the screw anti-rotation means preferably act in the same direction. In particular in the case of the screw anti-rotation means, the described preferred direction can facilitate assembly significantly, because the screw can be tightened against comparatively low resistance, but the resistance to loosening is comparatively high. A preferred direction of the component anti-rotation means can support the effect of the screw anti-rotation means.

In embodiments, the insert threaded sleeve comprises a pull-out protection means, which is implemented by the component anti-rotation means configured on the outer surface of the shank portion or by separate structural elements on the outer surface of the shank portion, for example one or more peripheral grooves or peripheral furrows (knurls), or by an outer diameter of the shank portion dimensioned for compression relative to a nominal diameter of the bore of the receiving component receiving the shank portion. The preassembly of a component can be significantly improved by the pull-out protection means, because the sleeves can be captively preassembled in the component, possibly with screws.

In embodiments, the component anti-rotation means has knurling on the outer surface of the shank portion. The knurling can comprise knurls in the form of rib-shaped elevations (ribs, webs or teeth) or groove-shaped depressions (grooves) that extend axially or obliquely with respect to the sleeve axis in one direction or crosswise in two directions. The knurls can extend in a wavy or zigzag manner along a respective main direction. In further developments, the knurls can have a wedge-shaped cross-section with two flanks projecting from the surface. The flanks can in particular be symmetrical to one another. Such knurling ensures that material of the receiving component flows into the intermediate spaces when the sleeve is inserted, and the sleeve thus remains anchored in the bore in a non-rotatable manner. Knurls that extend at an angle to the sleeve axis can also serve as a pull-out protection means.

In embodiments, the component anti-rotation means comprises at least one claw, preferably multiple, in particular two, three or four claws, which projects from the underside of the disc portion and comprises an end that tapers to a point. The pointed end of the at least one claw can penetrate a surface of the component receiving the insert threaded sleeve and thus anchor itself against rotation, at least when certain axial contact pressure is applied to the insert threaded sleeve. The at least one claw may be formed by a punched and/or angled portion of the disc portion. If the at least one claw is angled about a line that is radial to the sleeve axis, it can comprise a comparatively flat ramp which extends from the bending line and a comparatively steep flank formed by a punched edge, which is one way to implement the preferred direction of the component anti-rotation means. If the at least one claw is angled about a line that is tangential to the sleeve axis at a radial distance, a symmetrical effect can be achieved if the two punched edges facing in circumferential direction are the same, or a preferred direction can be achieved if the punched edges facing in circumferential direction are different or one of them is ground to form a ramp.

In embodiments, the screw anti-rotation means has knurling. The knurling can comprise knurls in the form of groove-shaped depressions (grooves) or rib-shaped elevations (ribs, webs or teeth) that extend radially with respect to the sleeve axis. In further developments, the knurls can have a notch or wedge-shaped cross-section with two flanks that enter into the surface. The knurls can be configured symmetrically or asymmetrically to one another. First flanks of the knurls in a first direction of rotation about the sleeve axis can in particular be configured steeper than second flanks in the second direction of rotation about the sleeve axis, which is one way to implement the preferred direction of the screw anti-rotation means.

In embodiments, the through-hole can be configured as a stepped bore, wherein an inner diameter in a first hole portion in the region of the disc portion is smaller than an inner diameter of a second hole portion at the opposite end of the shank portion. The narrower first hole portion of the through-hole can in particular be configured to screw in a connecting screw to be received (hereinafter also referred to as “screw”) and the further second hole portion can be dimensioned wider than the nominal screw diameter of the screw, so that a thread of the screw can move freely inside it. A length of the first hole portion can furthermore be dimensioned shorter than a length of a free section of the screw. During preassembly then, the screw can be screwed into the narrower portion, while the screw thread can come free of the narrower portion when screwed into the structure to which the component supporting the sleeve is to be attached, which can significantly improve the clamping effect of the screw connection. The same effect can be achieved if the through-hole of the sleeve is configured without a step, but the sleeve itself has a length that is dimensioned shorter than a length of a free section of the screw. The length of the sleeve is preferably also considerably shorter than a wall thickness of a wall of the component, in which a bore for receiving the sleeve is configured.

According to a further aspect of the invention, a connecting screw comprising a screw head, a shank part adjoining the screw head and a threaded part adjoining the shank part is proposed, wherein an outer diameter of the shank part over the major part of its length is smaller than the core diameter of the threaded part, and wherein the head is provided with an underhead anti-rotation means on its underside. The underhead anti-rotation means can be configured to cooperate with a screw anti-rotation means on a surface of a counter element which faces the screw head when the connecting screw is used as intended. The counter element can be the above described sleeve with the screw anti-rotation means. However, this aspect of the invention is not limited to this. In fact, the underhead anti-rotation means on the screw head can penetrate a surface of a counter element during screwing, for example, if the material of said counter element is softer than the material of the connecting screw. For this purpose, the region of the screw head carrying the anti-rotation means can be especially hardened or made of a harder material, such as a harder metal, than the sleeve. The underhead anti-rotation means has the same effect or cooperates with the screw anti-rotation means of the sleeve and has the same advantages. In particular the inhibition in the loosening direction can reduce the required tightening torque. Due to the free-cut shank part, it becomes free when screwed through a screw-in part of a sleeve or other fastening bore and the connecting screw can therefore unfold the full clamping effect at the respective tightening torque when tightened. If the underhead anti-rotation means is configured to cooperate with the counter element in a finely graduated latching manner, monitoring of the tightening torque may also be unnecessary.

In embodiments, the underhead anti-rotation means can comprise a toothing having a plurality of teeth configured in radial direction. The teeth can be symmetrical or asymmetrical in cross-section in order to implement a direction-independent inhibition or a preferred direction. The toothing can be configured to cooperate with a knurling on a counter element.

In embodiments, the external thread may have a thread length corresponding to two to ten thread turns, preferably three to eight thread turns, particularly preferably four to six thread turns. The thread length can also be approximately equal to the nominal dimension of the external thread.

In embodiments, the shank part can have a shank length that is half to three times the thread length, preferably one to two times the thread length.

According to a further aspect of the invention, a screw-sleeve combination of an insert threaded sleeve as described above and a connecting screw as described above is proposed. This has its own respective individual advantages as well as combined advantages as described above. The connecting screw can advantageously be preassembled in the insert threaded sleeve. The connecting screw can be positioned according to customer requirements or workshop requirements, for example. It can be advantageous, for example, if the connecting screw is screwed fixedly into a screw-in part of the sleeve. In other situations, it can be advantageous if the connecting screw is screwed through the screw-in part and a narrower shank part between the screw head and the threaded part is disposed loosely in the screw-in part, so that the connecting screw as a whole is preassembled in the sleeve in a movable but captive manner.

According to a further aspect of the invention, a component, in particular a plug housing, preferably for a high-voltage plug connection is proposed, wherein the component comprises at least one fastening point which is preassembled with an insert threaded sleeve as described above or a screw-sleeve combination as described above. In each case, the same advantages are achieved as described above.

The sleeve can be made of a material, in particular a metallic material, that is harder than a material of the receiving component. In particular if the receiving component is made of plastic, its material can be displaced by raised parts of the component anti-rotation means when the sleeve is inserted and then flow back into the intermediate spaces.

### BRIEF DESCRIPTION OF THE DRAWINGS

Further features, advantages and objects of the invention will become apparent from the description of design examples with reference to the accompanying drawings. In the drawings, the figures are:

FIG. 1A to 1E a schematic illustration of an insert threaded sleeve according to a design example of the invention in a perspective view, a plan view, a side view, an axial sectional view and a detail “E”;

FIG. 2A to 2E a schematic illustration of a combination of a connecting screw with the insert threaded sleeve of FIG. 1A to 1E according to a design example of the invention in perspective views from below and above at an angle, a plan view, a side view and an axial sectional view;

FIG. 3 a section of a component comprising the preassembled combination of FIG. 2A to 2E in an axial section;

FIG. 4 a high-voltage plug housing as a design example of a component that is prepared for assembly with the insert threaded sleeve of FIG. 1A-1E or the combination of FIG. 2A to 2E or another insert threaded sleeve or screw-sleeve combination according to the invention;

FIG. 5A to 5E a schematic illustration of an insert threaded sleeve according to another design example of the invention in a perspective view, a plan view, two side views, and an axial sectional view;

FIG. 6A to 6E a schematic illustration of a combination of a connecting screw with the insert threaded sleeve of FIG. 5A to 5E according to a design example of the invention in perspective views from below and above at an angle, a plan view, a side view and an axial sectional view;

FIG. 7 a section of a component comprising the preassembled combination of FIG. 6A to 6E in an axial section.

### DETAILED DESCRIPTION

The figures are to be understood as purely schematic, without implying a limitation to specific angular or dimensional relationships, unless expressly so described. To simplify the description and without implying a limitation to an orientation in space, in the context of a described design example, a direction from which a test force is applied is considered to be vertically above, the opposite direction to be vertically below, a direction in extension of a perpendicular connection of axes of two guide rods of a parallel guide to be lateral, a direction perpendicular to the lateral direction and the vertical direction toward an interface unit to be the front and the opposite direction to be the rear, but this is completely arbitrary and for illustrative purposes only.

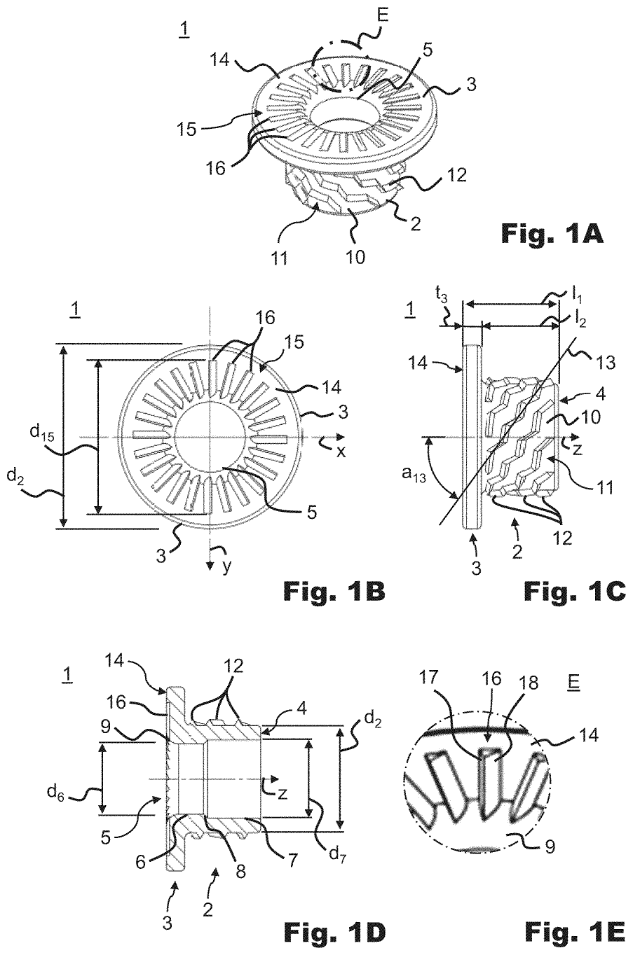

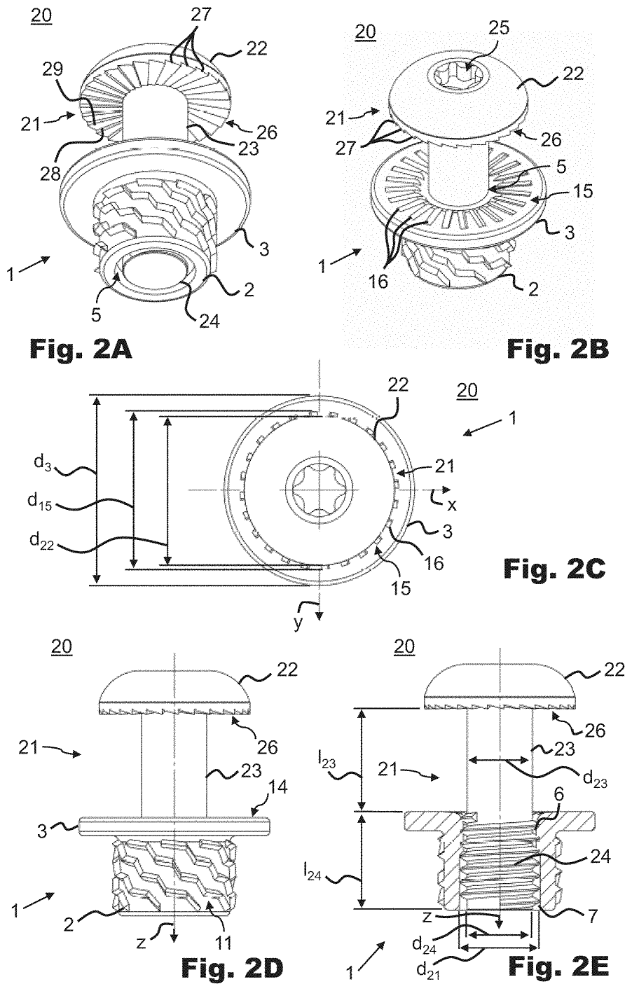

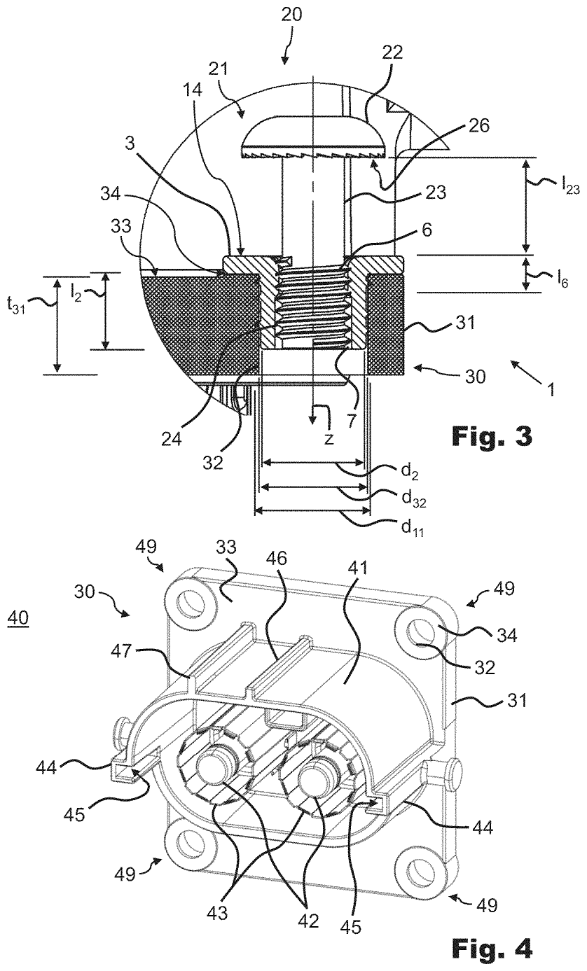

An insert threaded sleeve according to the invention 1 (hereinafter also simply referred to as “sleeve”) according to a first design example comprises a shank portion 2 and a disc portion 3 (FIG. 1A-1E). The shank portion 2 is configured to substantially extend in a cylindrical manner and extends along or defines a sleeve axis z. The disc portion 3 terminates the shank portion 2 at an axial end, which defines a plane x, y that extends at a right angle to the sleeve axis z and extends the shank portion 2 outward in the shape of a disc. The other axial end of the shank portion 2 is formed by a foot end 4. A through-hole 5 extends through the disc portion 3 and the shank portion 2 along the sleeve axis z. The through-hole 5 has a circular cross-section. The sleeve 1 is understood as an insert threaded sleeve, because it is configured for insertion into a bore of a receiving component by means of the shank portion 2 (see FIG. 3) and for receiving a screw bolt in the through-hole 5 (see FIGS. 2A-2E, 3).

In this design example, the through-hole 5 is configured as a stepped bore having a first hole portion 6 in the region of the axial end of the disc portion 3 and a second hole portion 7 (FIG. 1E). The first hole portion 6 has a diameter d6 and a length l6 and widens over a step 8 to the second hole portion 7 which has a diameter d7 and a length l7 and extends to the foot end 4 of the sleeve 1. The step 8 can be formed by a cylindrical counterbore and have a taper angle corresponding to the drill used. The through-hole 5 terminates in a chamfer 9 on the disc portion 3.

A component anti-rotation means 11 is configured on an outer surface 10 of the shank portion 2. The component anti-rotation means 11 serves to inhibit a rotation of the sleeve 1 relative to a fastening bore that receives the shank portion 2 about the sleeve axis z. The component anti-rotation means 11 can comprise a knurling having a plurality of knurls in the form of webs or ribs 12. In this design example, the ribs 12 extend in a zigzag manner along a respective main direction 13, which here extends obliquely to the sleeve axis z at an angle a13. The invention is not limited to this; the knurling can instead also be configured axially or crosswise in two directions. The ribs 12 can have a wedge-shaped cross-section with two flanks projecting from the surface. The flanks can in particular be symmetrical to one another. When the sleeve 1 is inserted into a bore of a receiving component, the ribs 12 can penetrate a wall of the hole and thereby anchor the sleeve in a non-rotatable manner. Due to the inclination angle a13 of the ribs 12, the component anti-rotation means 11 acts at the same time as a pull-out protection means, as an anchor against extraction of the sleeve 1 from the fastening bore.

A screw anti-rotation means 15 is configured on a surface 14 of the disc portion 3 facing away from the shank portion 2. The screw anti-rotation means 15 enables inhibition of rotation of a bolt head of a bolt inserted into the through-hole 5 from the axial end x, y relative to the insert threaded sleeve 1 about the sleeve axis z. The screw anti-rotation means 15 can comprise a knurling having a plurality of knurls in the form of furrows or grooves 16. In this design example, the grooves 16 extend radially outward in the plane x-y from an edge of the through-hole 5. The grooves 16 can end within the surface 14 such that the knurling of the screw anti-rotation means 15 describes an outer diameter d16 that is less than an outer diameter d3 of the disc portion 3. This can also avoid sharp edges on the outer side of the disc portion 3 and reduce the risk of injury during handling. The grooves 16 can have a wedge-shaped cross-section with two flanks. A first groove flank 17 can be steeper relative to the surface 14 than a second groove flank 18. A preferred direction can thereby be imparted to the screw anti-rotation means device 15. This can facilitate tightening via the flatter second groove flank 18 and at the same time improve the inhibiting effect of the steeper first groove flank 17 against loosening. In other words, the first groove flank 17 can act as an inhibiting flank and the second groove flank 18 can act as a sliding flank. In modifications, however, the groove flanks 17, 18 can also be symmetrical to one another.

The sleeve 1 unfolds specific advantages in a combination 20 with a connecting screw 21 (FIGS. 2A-2E, 3). The combination 20 and the connecting screw 21 are both independent design examples of the invention.

The connecting screw 21 comprises a screw head 22, a shank part 23 adjoining the screw head 22 and a threaded part 24 adjoining the shank part 23. The shank part 23 is configured as an undercut relative to the threaded part 24. In other words, an outer diameter d23 of the shank part 23 over the major part of its length l23 is smaller (i.e. apart from any transition radii) than the core diameter d24 of the threaded part 24. The nominal diameter (thread outer diameter) d21 of the connecting screw 21 is furthermore greater than the inner diameter d6 of the first hole portion 6 of the sleeve 1, but smaller than the inner diameter d7 of the second hole portion 7 of the sleeve 1. The length l23 of the shank part 23 of the connecting screw 21 is also greater than the length l6 of the first hole portion 6 of the sleeve 1. In other words, the connecting screw 1 can first be screwed into the first hole portion 6 of the sleeve 1 and thereby held in a captive manner so that a preassembly of the connecting screw 1 becomes particularly easy to handle and reliable. When the connecting screw 1 is screwed through the first hole portion 6, the threaded part 24 enters the region of the second hole portion 7 and the shank part 23 enters the region of the first hole portion 6. Due to the diameter relationships, free movement of the connecting screw 21 in the through-hole 5 of the sleeve 1 is then possible, but the connecting screw 21 remains captive in the sleeve 1. Moreover, the flow of force is established, so that the connecting screw 21 can unfold the full clamping effect when tightened. The screw thread of the threaded part 24 can be configured to be thread-forming or thread-cutting in order to screw into the first hole portion 6 of the sleeve 1. Alternatively, an internal thread can already be provided in the first hole portion 6 of the sleeve 1, in which case a thread-forming or thread-cutting configuration of the threaded part 24 is not required.

The screw head 22 comprises a drive 25 which can assume any conceivable shape; in this case is configured as a hexagon socket (Torx). The underside of the screw head 22 is provided with an underhead anti-rotation means 26. The underhead anti-rotation means 26 serves to inhibit a rotation of the connecting screw 21 in loosening direction relative to a counter element, in this case the sleeve 1, when the connecting screw 21 is tightened. The underhead anti-rotation means 26 comprises a toothing having a plurality of teeth 27 that are configured in radial direction. In this design example, the teeth 27 are configured from the outer surface of the shank part 23 to the edge of the underside of the head. In modifications, the teeth 27 can also start a distance away from the outer surface of the shank part 23, also in dependence of a configuration of a hole edge (here the edge of the through-hole 5 of the sleeve 1 with the chamfer 9). In this design example, the teeth 27 are configured with a wedge-shaped cross-section, whereby a first tooth flank 28 can be steeper relative to the underside of the screw head 22 than a second tooth flank 29. This can facilitate tightening via the flatter second tooth flank 29 and at the same time improve the inhibiting effect of the steeper first tooth flank 28 against loosening. In other words, the first tooth flank 28 can act as an inhibiting flank and the second tooth flank 29 can act as a sliding flank. In modifications, however, the tooth flanks 28, 29 can also be symmetrical to one another. A direction-independent inhibition or a preferred direction of the underhead anti-rotation means 26 can thus be implemented.

In the combination 20 with the sleeve 1, the toothing of the underhead anti-rotation means 26 26 of the connecting screw can be configured to cooperate with the knurling of the screw anti-rotation means 15 on the sleeve 1 or vice versa. In other words, the cross-sectional shape of the teeth 27 can be configured to match the cross-sectional shape of the grooves 16 or vice versa, so that the respective inhibiting flanks 17, 28 lie on top of one another as parallel as possible to inhibit a rotation between the connecting screw 21 and the sleeve 1 in the loosening direction. Loosening is consequently now possible only with a high loosening torque suitable to overcome the slope of the inhibiting flanks 17, 28, so that unintended loosening is practically prevented. It should be noted that the connection can become practically unreleasable if the inhibiting flanks 17, 28 have an undercut.

When the connecting screw 21 is tightened, the sliding flanks 29 of the underhead anti-rotation means 26 of the connecting screw 21 can slide over the sliding flanks 18 of the screw anti-rotation means 15 of the sleeve 1 until the teeth 27 slide over the edge and slip into the grooves 16. This results in a latching effect. In the present design example, the number of teeth 27 and grooves 16 is so large that the latching effect is finely graduated. As a result, the tightening torque can be well controlled without having to check it by measurement. The worker can simply overcome a certain number of catches stipulated by the requirements specification and can then be sure that the connection will not loosen.

If the number of teeth 27 is equal to or a whole number multiple of the number of grooves 16 or vice versa, all of the teeth 27 and grooves 16 will always engage so that the resistance to loosening is very high. If the number of teeth 27 and grooves 16 deviates from this, the resistance to loosening may be lower, but the latching effect can be more finely graduated.

A component 30 can comprise a wall 31, in which a fastening bore 32 for receiving the insert threaded sleeve 1 is configured (FIG. 3). A hole reinforcement 34 in the form of a flat elevation can be provided in a surface 33 of the wall 31, whereby the elevation may have undergone appropriate planarizing machining. When the sleeve 1 is inserted, the ribs of the component anti-rotation means 15 carve into the wall of the fastening bore 32 and anchor the sleeve 1 in the fastening bore 32 such that it cannot rotate and cannot be pulled out. The disc portion 3 of the sleeve 1 lies flat on the component 30. The connecting screw 21 is screwed into the first hole portion 6 of the sleeve 1. The connecting screw 21 is thus disposed or preassembled in the sleeve 1 in a captive manner. The sleeve 1 can comprise the screw anti-rotation means 15, and/or the connecting screw 21 can comprise the underhead anti-rotation means. Loosening of the connecting screw 21 can thus be prevented as soon as it has been tightened such that the screw head 22 is seated tightly on the sleeve 1 and the screw anti-rotation means 15 and/or the underhead anti-rotation means 26 engage and/or interlock.

As a result of this protection, only a small amount of pretension is required to securely fasten the component 30 to a support structure (not shown). The threaded part 24 can therefore be comparatively short, and the pressing force and the associated squeezing of the component 30 can be small. For example, a thread length l24 of the threaded part 24 can correspond to two to ten thread turns, whereby three to eight thread turns, possibly four to six thread turns, can often suffice. The thread length l24 can also be approximately equal to the nominal dimension d21 of the screw 21.

The shank part 23 can have a shank length l23 that is half to three times the thread length l24, preferably one to two times the thread length l24. The shank length l23 can also be adapted to the component wall thickness t31 plus a disc thickness t3, if applicable plus a gap length between the component 30 and the support structure or the start of a nut thread in the support structure and, if applicable, plus safety allowances of, for example, 0.5 to two thread turns.

It is therefore not necessary for the bolt force to be introduced into the support structure via the sleeve 1 and the sleeve can be shorter than the thickness t31 of the component wall 31. This can save further weight and reduce the requirements for the manufacturing accuracy of the sleeve 1 and the component wall 31. The component 30 with the preassembled sleeve 1, with or without a preassembled connecting screw 21, is a further design example of the invention.

The invention can advantageously be used with a high-voltage plug 40 (FIG. 4). High-voltage plugs are becoming increasingly important in the automotive industry with the growing prevalence of electric vehicles, as the drive energy there has to be provided and transmitted at a comparatively high voltage. For insulation purposes, such a plug housing is often made of plastic and has to be fastened to support structures such as generators, battery units, energy distributors, control devices and motor units in a particularly reliable and non-loosening manner. As the number of contact points to be assembled increases, so does the importance of increasing the manufacturing efficiency during assembly. The high-voltage plug 40 can comprise a plug housing as the component 30 in the sense of the invention. The plug housing 30 can comprise a contact enclosure 41, for example, that projects from a component wall 31 and in which a plurality of contacts 42 (pins or sleeves) are disposed (assembled or cast) in respective individual contact insulations 43. Guide ribs 44, 46 and guide grooves 45, reverse polarity protection elements 47 (here another eccentrically arranged guide rib, for example), positioning aids (not shown in more detail), etc. can be provided for secure positioning on a support structure. The component wall 30 can comprise four fastening points 49, for example, each of which is defined by a fastening bore 32, possibly configured in a hole reinforcement 34. A high-voltage plug 40 or plug housing 30 with preassembled insert threaded sleeves 1, with or without a preassembled connecting screw 21, is respectively a further design example of the invention.

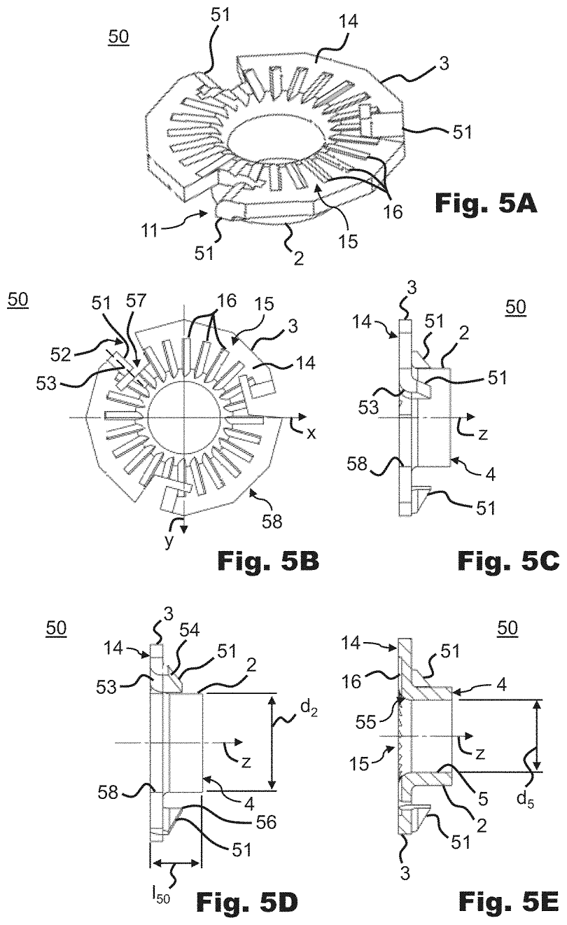

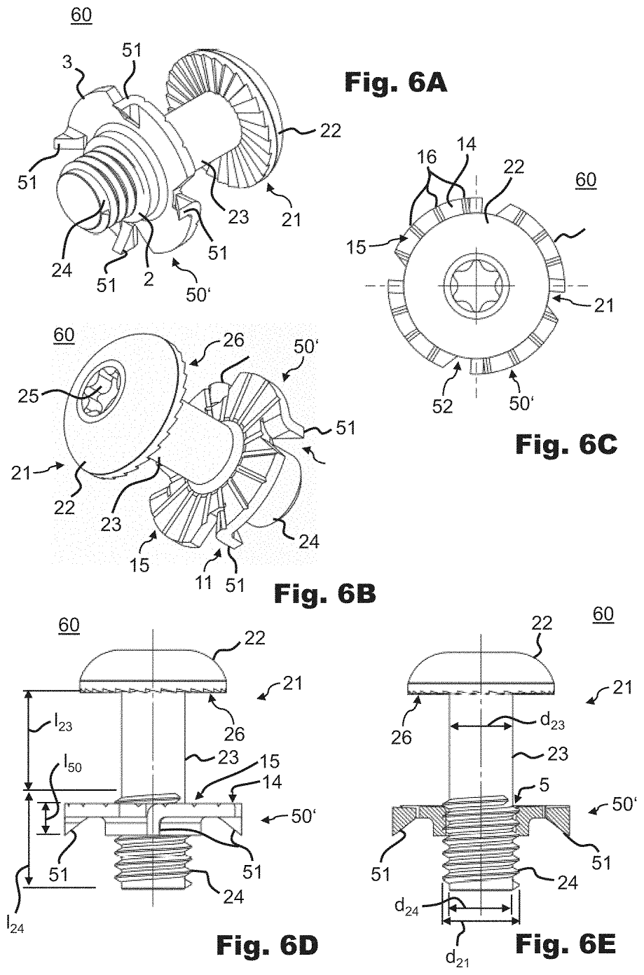

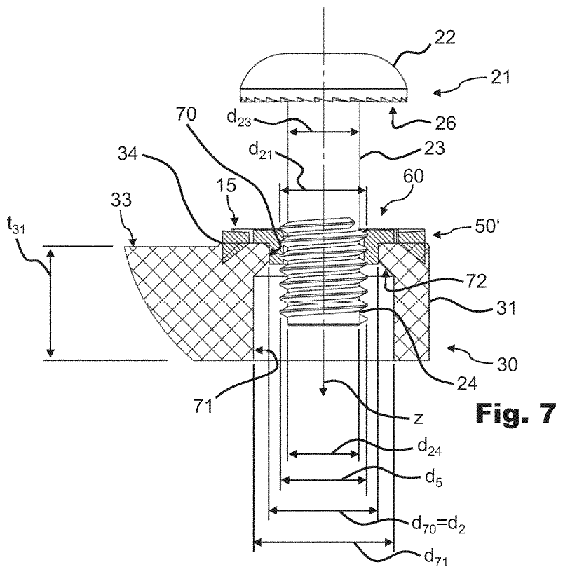

An insert threaded sleeve 50 according to the invention according to a further design example of the invention is similar to the insert threaded sleeve 1 of the first design example with a shank portion 2, a disc portion 3 and a through-hole 5 (FIGS. 5A-5E), but has some structural and functional differences. As before, the sleeve 50 unfolds special advantages in a combination 60 with a connecting screw 21 (FIGS. 6A-6E, 3) and with a component 30 (FIG. 7), which are likewise respectively independent design examples of the invention.

The essential aspects of the differences to the insert threaded sleeve 1 of the first design example and design examples derived from it are described in the following. Unless stated otherwise below, with respect to features, structural details and effects, reference can be made to the first design example with the design examples derived from it, individually or in combination with one another.

The shank portion 2 of the sleeve 50 can be formed by drawing from the disc portion 3, whereby the through-hole 5 can also be configured at the same time. The through-hole 5 here is completely smooth and has a rounding 55 only in the region of the disc portion 3, which may have been created by the drawing process. The through-hole 5 as a whole can thus have a diameter d5, which corresponds approximately to a nut core diameter of an associated connecting screw. Alternatively, the through-hole 5 as a whole can have an internal thread that corresponds to the nominal diameter of an associated connecting screw. The overall length l50 of this sleeve 50 can accordingly be less than the length l1 of the sleeve 1 in the first design example.

The outer surface 10 of the shank portion 2 in this design example is smooth. A component anti-rotation means 11 is formed by claws 51 produced by punched-out parts of the disc portion 3. More specifically, punched-out portions 52 are formed in an edge of the disc portion. In the process, tabs were left on the disc portion 3, which are bent downward about a radially or approximately radially extending bending line 53 to form the claws 51. To achieve a better penetration effect into a surface 33 of a component 30 (FIG. 7), the claws 51 have a bevel 54 that forms a point 56. A prepunch 57, which removes an approximately rectangular section from the disc portion 3 radially inside the claws 51 so that the punched-out tab (the eventual claw 51) can bend freely about the bending line 53, can be provided to facilitate punching. As in the first design example, the component anti-rotation means 11 with its claws 51 serves to inhibit a rotation of the sleeve 1 relative to a fastening bore that receives the shank portion 2 about the sleeve axis z, but, as described, is configured differently.

In this design example, the claws 51 of the component anti-rotation means 11 do not provide pull-out protection. However, by dimensioning the outer diameter d2 of the shank portion 2 to be pressed to a fastening bore 32 in the component 30, pull-out protection can be provided by a friction fit, which can be sufficient for the purpose of loss protection when assembling the preassembled component 30. When the component 30 is assembled, the pull-out protection of the sleeve 11 is no longer important.

The screw anti-rotation means 15 can be configured on the upper side 14 of the disc portion 3 as in the first design example.

As a further option, in the present design example, the disc portion can have an edge configured as an outer polygon 58. The outer polygon 58 can provide a predetermined suitable width across flats. The connecting screw 21 can thus be screwed into the sleeve 50′ in advance, for example, and provided preassembled as a combination 60. The combination can then be hammered into a fastening bore 32 or a surface 33 or hole reinforcement 34 of a component 30 as a whole.

A screw-sleeve combination 60 comprises an insert threaded sleeve 50′ according to a further design example and the already described connecting screw 21 (FIGS. 6A-6E). The insert threaded sleeve 50′ used here differs from the previously described insert threaded sleeve 50 by a smooth edge 59 of the disc portion 3, the grooves 16 of the screw anti-rotation means 15 that extend all the way to the edge 59, and four instead of three claws 51. The number of claws 51 can be modified as needed.

The connecting screw 21 has already been described above. In the present design example with the modified sleeve 50′ (the same would apply to the sleeve 50), the nominal diameter d21 of the connecting screw 21 is greater than the inner diameter d5 of the completely smooth through-hole 5 of the sleeve 50′ (50) and the length123 of the shank part 23 of the connecting screw 21 is greater than the overall length150 of the sleeve 50′ (50). The overall length l50 of the sleeve 50′ (50) can correspond approximately to the length16 of the first hole portion 6 in the first design example. The connecting screw 21 can thus first be screwed into the entire through-hole 5 of the sleeve 50′ (50) and the threaded part 24 comes free as the connecting screw 21 is screwed further through the through-hole 5 while the shank part 23 enters the region of the first through-hole 5. The same applies to the diameter relationships as in the case of the sleeve 1 of the first design example, so that a captive preassembly can be made possible and a reliable flow of force can be produced.

As already described, the screw head 22 is provided with the underhead anti-rotation means 26, so that the associated effects will be achieved.

Since the sleeve 50′ (50) of the present design example can be shorter overall than the sleeve 1 of the first design example, the wall thickness t31 of the wall 31 of a component 30 into which the sleeve 50′ (50) is inserted can also be thinner as far as permitted by the other mechanical and electrical requirements. If the component wall 31 is thicker than the sleeve 50′ (50), the fastening bore 32 in the component 30 can comprise a first hole portion 70, the outer diameter d70 of which is adapted to the outer diameter d2 of the shank portion 2 of the sleeve 50′ (50), and a second hole portion 71, the diameter d71 of which is larger than the first hole portion 70, with a possibly conical step 72 in between (FIG. 7). The outer diameter d70 of the first hole portion 70 can be dimensioned for compression with the outer diameter d2 of the shank portion 2 of the sleeve 50′ (50), such that sufficient pull-out protection to secure against loss is provided by a friction fit. The second hole portion 71 can be dimensioned more freely. Optional shaped elements on the outer side of the shank portion 2 of the sleeve 50′ (50), such as an annular groove or an annular web or foot-side annular bead, can support the pull-out protection with a form fit.

The sleeve 1, 50, 50′ can be made of a material, in particular a metallic material, that is harder than a material of the receiving component 30. In particular if the receiving component 30 is made of plastic, its material can be displaced by raised parts of the component anti-rotation means 11 when the sleeve 1, 50, 50′ is inserted and then flow back into the intermediate spaces.

In particular in combination, but also individually, the insert threaded sleeve 1, 50, 50′ according to the invention and the connecting screw 21 according to the invention can act as a compression limiter, which can, but does not necessarily have to, transmit a pretensioning force through the component 30 to be assembled and on to a support structure.

The sleeve 1, 50, 50′ can be provided with a, for example metric, thread-forming/thread-cutting or form-locking contour.

A screw preassembly can be produced by a friction and/or a form fit. An axially freely movable screw preassembly or an axially fixed screw preassembly can be provided as desired.

The sleeve 1, 50, 50′ can be provided with metric, thread-forming/thread-cutting and form-locking contours.

The sleeve 1, 50, 50′ can have a closed or an open contour. It can, for example, be produced by deep drawing, cold working or rolling, casting and/or machining, embossing, or punching.

Knurlings, which in design examples are configured as elevations, can also be configured as depressions and vice versa.

The invention has been described above on the basis of design examples and variants (which can also be referred to as modifications, further developments, alternatives or options). The invention itself is defined by the attached claims. The illustration and description of the design examples serve the purpose of explaining and understanding the claimed invention. Individual features of a design example or its variants can be combined with any other design example or related variant and shall also be considered disclosed in this sense, even if they are not expressly described in the context, unless this would be obviously impossible or pointless for technical or physical reasons. For example, the component anti-rotation means 11 can comprise both the knurls or the webs 12 and the claws 51. Conversely, individual features of a design example or its variants do not limit an invention and can be omitted if the remaining combination of features solves a technical problem. In particular, any combination of individual features described here that solve a technical problem in a non-obvious manner can form a separate subject matter of the invention.

### LIST OF REFERENCE SIGNS

1 Insert threaded sleeve
2 Shank portion
3 Disc portion
4 Foot end
5 Through-hole
6 First bore portion
7 Second bore portion
8 Step
9 Chamfer (counterbore)
10 Outer surface
11 Component anti-rotation means
12 Knurls (web, rib)
13 Main direction
14 Surface
15 Screw anti-rotation means
16 Knurls (furrow, groove)
17 First groove flank (inhibiting flank)
18 Second groove flank (sliding flank)
20 Combination
21 Connecting screw
22 Head
23 Shank part
24 Thread
25 Drive
26 Underhead anti-rotation means
27 Tooth
28 First tooth flank (inhibiting flank)
29 Second tooth flank (sliding flank)
30 Component
31 Wall
32 Fastening bore
33 Surface
34 Hole reinforcement
41 Contact enclosure
42 Contact
43 Contact insulation
44 Guide rib
45 Guide groove
46 Guide rib
47 Reverse polarity protection element
49 Fastening point
50 Insert threaded sleeve
51 Claw
52 Punched-out portion
53 Bending portion
54 Bevel
55 Rounding
56 Point
57 Prepunch
58 Outer polygon
59 Edge
60 Combination
70 First hole portion
71 Second hole portion
72 Step
a Angle *)
d Diameter *)
l Length *)
t Thickness *)
x, y Radial direction
z Sleeve axis, axial direction
*) A suffix indicates the component to which the dimension relates.

The foregoing list is an integral part of the description.

What is claimed is:

1. Insert threaded sleeve (1; 50; 50′), which comprises:
a shank portion (2), which extends substantially cylindrically along a sleeve axis (z) and is configured for insertion into a hole or a bore;
a disc portion (3), which terminates the shank portion (2) at an axial end and extends it outward at a right angle to the sleeve axis (z);
a through-hole (5), which extends along the sleeve axis (z) through the disc portion (3) and the shank portion (2) and is configured to receive a screw bolt;
a component anti-rotation means (11), which is configured on an outer surface (10) of the shank portion (2) or on an underside of the disc portion (3) facing toward the shank portion (2); and
a screw anti-rotation means (15), which is configured on a surface (14) of the disc portion (3) facing away from the shank portion (2).

2. Insert threaded sleeve (1; 50; 50′) according to claim 1, wherein
the component anti-rotation means (11) and/or the screw anti-rotation means (15) has a preferred direction, wherein the preferred directions of the component anti-rotation means (11) and the screw anti-rotation means (15) act in the same direction.

3. Insert threaded sleeve (1; 50; 50′) according to claim 1, wherein
a pull-out protection means is provided, which is implemented by the component anti-rotation means (11) configured on the outer surface (10) of the shank portion (2) or by separate structural elements on the outer surface of the shank portion (2).

4. Insert threaded sleeve (1; 50; 50′) according to claim 1 wherein
the component anti-rotation means (11) has knurling on the outer surface (10) of the shank portion (2), which includes knurls (12) in the form of rib-shaped elevations or groove-shaped depressions that extend axially or obliquely with respect to the sleeve axis (z) in one direction or crosswise in two directions, wherein the knurls (12) extend in a wavy or zigzag manner along a respective main direction (13).

5. Insert threaded sleeve (1; 50; 50′) according to claim 1, wherein
the component anti-rotation means (11) comprises at least one claw (51), which projects from the underside of the disc portion (3) and comprises an end (56) that tapers to a point, wherein the at least one claw (51) is formed by a punched and/or angled section of the disc portion (3).

6. Insert threaded sleeve (1; 50; 50′) according to claim 1, wherein
the screw anti-rotation means (15) has knurling, which comprises knurls (16) in the form of groove-shaped depressions or rib-shaped elevations that extend radially with respect to the sleeve axis (z), wherein the knurls (16) have a symmetrical or asymmetrical notch-shaped or wedge-shaped cross-section with two flanks (17, 18) that enter into the surface (14).

7. Insert threaded sleeve (1; 50; 50′) according to claim 1, wherein
the through-hole (5) is configured as a stepped bore, wherein an inner diameter (d6) in a first hole portion (6) in the region of the disc portion (3) is smaller than an inner diameter (d7) of a second hole portion (7) at the opposite end of the shank portion (2).

8. Connecting screw (21) comprising a screw head (22), a shank part (23) adjoining the screw head (22) and a threaded part (24) adjoining the shank part (23), wherein an outer diameter (d23) of the shank part (23) over the major part of its length (l23) is smaller than the core diameter (d24) of the threaded part (24), and wherein the head (22) is provided with an underhead anti-rotation means (26) on its underside, wherein the underhead anti-rotation means (26) comprises a toothing having a plurality of teeth (27) which are symmetrical or asymmetrical in cross-section and extend in radial direction.

9. Screw-sleeve combination (20; 60) of an insert threaded sleeve (1; 50; 50′) according to claim 1 and a connecting screw (21), wherein the connecting screw (21) is preassembled in the insert threaded sleeve (1; 50; 50′).

10. Component (30), configured as a plug housing, wherein the component (30) comprises at least one fastening point (49), which is preassembled with an insert threaded sleeve (1; 50; 50′) according to claim 1.

11. Screw-sleeve combination (20; 60) according to claim 9, wherein the connecting screw (21) comprises a screw head (22), a shank part (23) adjoining the screw head (22) and a threaded part (24) adjoining the shank part (23), wherein an outer diameter (d23) of the shank part (23) over the major part of its length (l23) is smaller than the core diameter (d24) of the threaded part (24), and wherein the head (22) is provided with an underhead anti-rotation means (26) on its underside, wherein the underhead anti-rotation means (26) comprises a toothing having a plurality of teeth (27) which are symmetrical or asymmetrical in cross-section and extend in radial direction.

12. Component (30), configured as a plug housing, wherein the component (30) comprises at least one fastening point (49), which is preassembled with a screw-sleeve combination (20; 60) according to claim 9.
